(19) United States
(12) Patent Application Publication
(10) Pub. No.: US 2012/0325814 A1
(43) Pub. Date: Dec. 27, 2012

(54) Fuel cap cover

(76) Inventor: Stephen George Crowley, Ashhurst (NZ)

(21) Appl. No.: 13/602,400

(22) Filed: Sep. 4, 2012

(30) Foreign Application Priority Data
Nov. 26, 2010 (NZ) 589025

(51) Int. Cl. B65D 55/16

(52) U.S. Cl. 220/212.5

(57) ABSTRACT

A fuel cap cover is secured to a fuel cap. The cap has a screw thread at one end part and a hand grip at an opposite end part. The cover comprises a body and a cord, the body having a slot through which the hand grip protrudes in a direction the same as or generally parallel to a main longitudinal axis of the cap. The cord is fixed to the body and to a motor vehicle so that the fuel cap can be turned by way of the hand grip to open and close a fuel tank of the vehicle.

### FIELD OF INVENTION

This invention relates to a cover for a motor vehicle fuel cap.

### BACKGROUND

It is possible for the fuel cap of a motor vehicle to get misplaced or lost during fuelling of the vehicle. It is accordingly an object of a preferred form of the present invention to to go at least some way towards addressing this problem, or to at least provide the public with a useful choice.

The term “comprising” and derivatives thereof, eg “comprises”, if and when used herein in relation to a combination of features should not be taken as excluding the possibility that the combination may have further unspecified features.

### SUMMARY OF INVENTION

According to one aspect of the invention there is provided a fuel cap cover secured to a fuel cap, the cap having a screw thread at one end part thereof and a hand grip at an opposite end part thereof, the cover comprising a body and a cord, the body having a slot through which the hand grip protrudes in a direction the same as or generally parallel to a main longitudinal axis of the cap, the cord being fixed to the body and to a motor vehicle so that the fuel cap can be turned by way of the hand grip to open and close a fuel tank of the vehicle.

Preferably the body is disc shaped.

Preferably the slot extends across a central part of the body.

Preferably the slot is generally rectangular.

Preferably the cord runs around a groove of the body.

Preferably the cord comprises rubber.

According to a further aspect of the invention there is provided a fuel cap cover formed so that it is suitable for use with a fuel cap, the fuel cap cover comprising a cord and a body having a slot therein.

Preferably the body is disc shaped.

Preferably the slot extends across a central part of the body.

Preferably the slot is generally rectangular.

Preferably the cord runs around a groove of the body.

Preferably the cord comprises rubber.

### GENERAL DESCRIPTION OF THE DRAWINGS

Some preferred embodiments of the invention will now be described by way of example and with reference to the accompanying drawings, of which:

FIG. 1 is a perspective view of a body of a fuel cap cover;

FIG. 2 is a top plan view of the body of the fuel cap cover;

FIG. 3 is a bottom plan view of the body of the fuel cap cover;

FIG. 4 is a perspective view of the assembled fuel cap cover; and

FIG. 5 is a perspective view of the fuel cap cover in use with a fuel cap.

### DETAILED DESCRIPTION

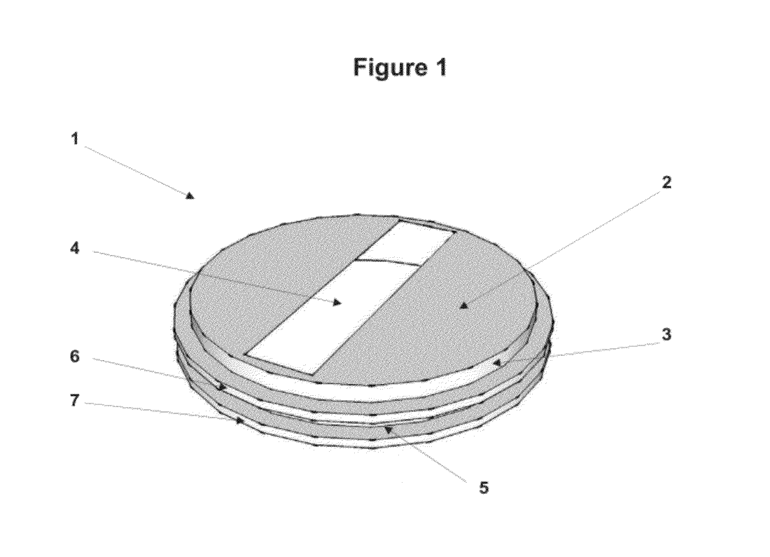

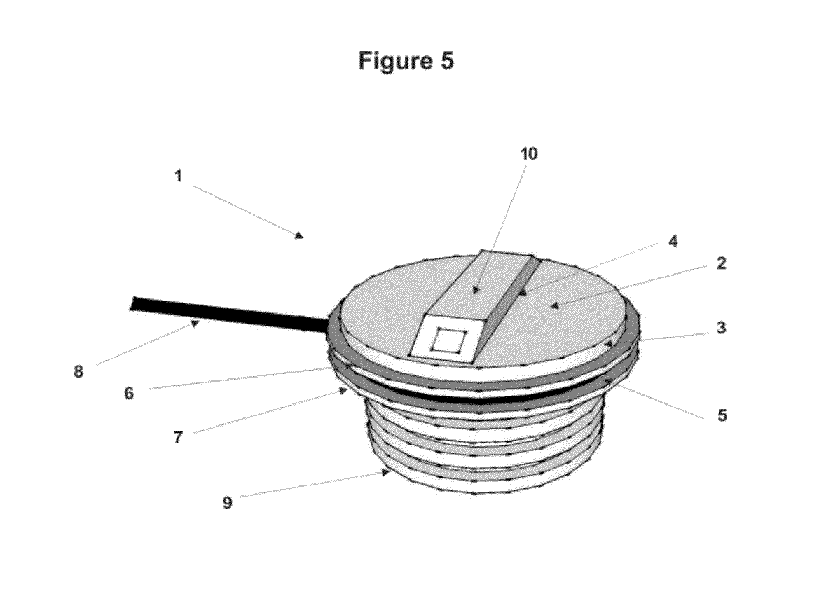

Referring to FIG. 1, the fuel cap cover 1 for the fuel cap 9 (shown in FIG. 5) of a motor vehicle fuel tank (not shown) is generally in the form of a disc. The cover 1 has a top face 2 and a wall 3 which runs around the circumference of the face 2. There is a rectangular slot 4 in the surface of the face 2. A groove 5 runs around the outside of the wall 3 and is defined by a first ridge 6 and a second ridge 7. The cover 1 is made of plastic but may be made of another suitable material.

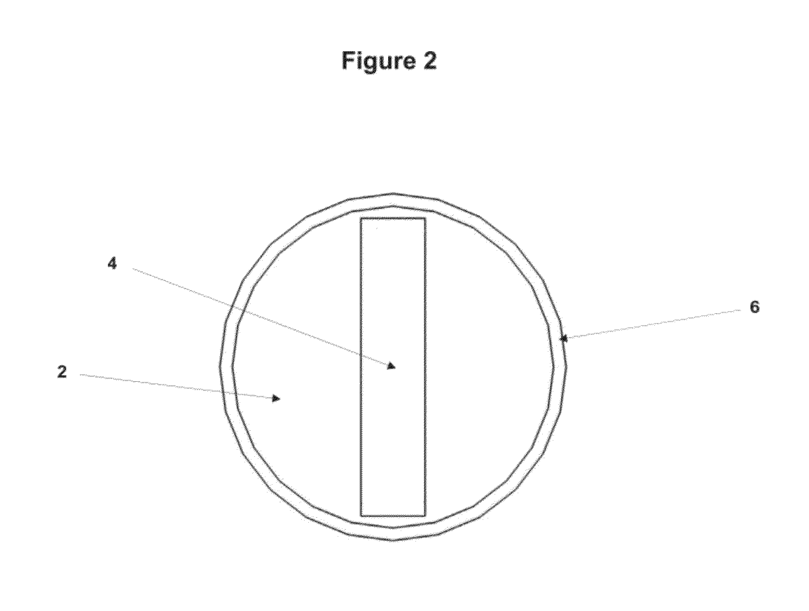

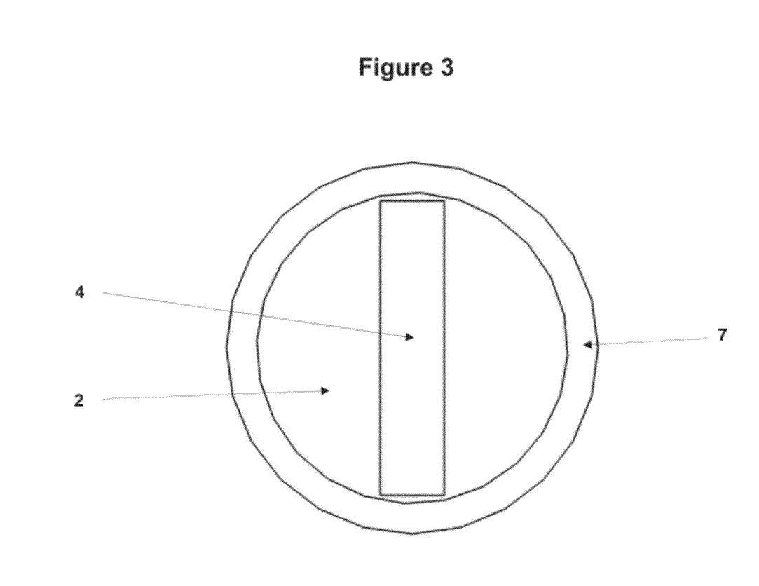

The top view of FIG. 2 shows the slot 4 in the face 2 with the first ridge 6 protruding beyond the face 2. In FIG. 3, the underside of the face 2, the slot 4 and the base of the lower second ridge 7 are visible.

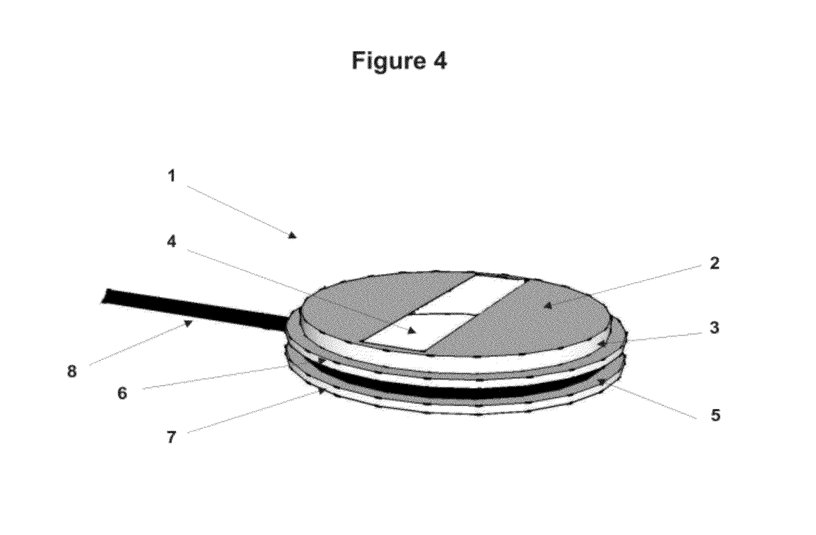

Referring to FIG. 4, one end of a cord 8 is wound around the wall 3 within the groove 5 between the first ridge 6 and the second ridge 7 to form a loop. The cord is made of rubber but may also be made of another suitable material. For example, the cord may be a chain or wire, or may be in the form of a natural or synthetic string.

FIG. 5 shows the cover 1 when attached to the fuel cap 9. The fuel cap 9 has a threaded lower portion which screws into a fuel tank inlet (not shown) to close the fuel tank. When in use the cover 1 is placed over the cap 9 so that the hand grip 10 of the cap 9 passes through the slot 4 of the cover 1. Glue is applied to the underside of the face 2 and/or to an upper surface of the cap 9 to secure the cap 9 to the cover 1. This avoids the need to drill into the cap 9 to secure it to the cover 1. Alternatively other forms of adhesive or fixing may be used to join the cover 1 and the fuel cap 9 together. When in use the cord 8 loops around the rest of the cover 1 and at the other end to an external part of a motor vehicle, for example a flap (not shown) used to cover the fuel tank inlet. Alternatively the cord 8 is secured to some other part of the vehicle near the fuel tank.

When a motorist stops at a petrol station to refuel the motor vehicle, the hand grip 10 of the fuel cap 9 is turned to unscrew the cap 9 and remove it from the fuel tank. The hand grip 10 is able to rotate with respect to the loop so that the cord 8 does not get tangled when the cap 9 is screwed or unscrewed. As the cap 9 is joined to the cover 1 which is connected to the vehicle by the cord 8, it is therefore attached to the vehicle at all times so that it cannot be misplaced or lost during refuelling. When the refuelling is completed the cap 9 is screwed back on the fuel tank inlet.

While some preferred forms of the invention have been described by way of example it should be appreciated that modifications and improvements can occur without departing from the scope of the appended claims.

1. A fuel cap cover secured to a fuel cap, the cap having a screw thread at one end part thereof and a hand grip at an opposite end part thereof, the cover comprising a body and a cord, the body having a slot through which the hand grip protrudes in a direction the same as or generally parallel to a main longitudinal axis of the cap, the cord being fixed to the body and to a motor vehicle so that the fuel cap can be turned by way of the hand grip to open and close a fuel tank of the vehicle.

2. A fuel cap cover according to claim 1, wherein the body is disc shaped.

3. A fuel cap cover according to claim 1, wherein the slot extends across a central part of the body.

4. A fuel cap cover according to claim 1, wherein the slot is generally rectangular.

5. A fuel cap cover according to claim 1, wherein the cord runs around a groove of the body.

6. A fuel cap cover according to claim 1, wherein the cord comprises rubber.

7. A fuel cap cover formed so that it is suitable for use with a fuel cap as described in claim 1, the fuel cap cover comprising a cord and a body having a slot therein.

8. A fuel cap cover according to claim 7, wherein the body is disc shaped.

9. A fuel cap cover according to claim 7, wherein the slot extends across a central part of the body.

10. A fuel cap cover according to claim 7, wherein the slot is generally rectangular.

11. A fuel cap cover according to claim 1, wherein the cord runs around a groove of the body.

12. A fuel cap cover according to claim 1, wherein the cord comprises rubber.

13. A fuel cap cover according to claim 1, substantially as herein described with reference to the accompanying drawings.

14. A fuel cap cover according to claim 7, wherein the cord runs around a groove of the body.

15. A fuel cap cover according to claim 7, wherein the cord comprises rubber.

16. A fuel cap cover according to claim 7, substantially as herein described with reference to the accompanying drawings.
